(19) United States
(12) Patent Application Publication
(10) Pub. No.: US 2008/0251446 A1
(43) Pub. Date: Oct. 16, 2008

(54) "PRE-FILLED AND SEALED FILTER BAG"

(75) Inventors: Erling Vangedal-Nielsen, Vedbaek (DK); Rene Munch Kjaer, Lille Skensved (DK); Georg Thorvald Gran, Lille Skensved (DK)

Correspondence Address: KLEIN, O'NEILL & SINGH, LLP, 43 CORPORATE PARK, SUITE 204, IRVINE, CA, 92606, US

(73) Assignee: AQUA PURO DANMARK A/S, Lille Skensved (DK)

(21) Appl. No.: 11/569,428

(22) PCT Filed: May 19, 2005
(86) PCT No.: PCT/DK2005/000333

§ 371 Date: May 16, 2008

(30) Foreign Application Priority Data
May 19, 2004 (EP) 04388035.0

(51) Int. Cl. B01D 39/16

(52) U.S. Cl. 210/500.4

(57) ABSTRACT

A pre-filled and sealed filter bag, is provided including calcium carbonate material having fine pores and two sheets of filter paper having substantially similar geometrical shape and dimensions and defining an outer periphery. The calcium carbonate material is selected from coral sand, oysters shells and/or crab shells. A peripheral joint extends along the outer periphery of the sheets of filter paper and joins the sheets together substantially overlapping one another to define an inner chamber within the interior of the bag in which the calcium carbonate material is enclosed. Each of the two sheets of filter paper define within the peripheral joint an air and water permeable filter area of a minimum of 900 mm². The weight of the two sheets of filter paper material constitute more than 1/8 (12.5%) of the weight of the material contained within the filter bag.

The present invention relates generally to a technique of rinsing water by using calcium carbonate material having fine pores and more particularly, the present invention relates to a novel pre-filled and sealed filter bag containing such material.

The technique of using calcium carbonate for rinsing water is fairly old and described in numerous publications, among others U.S. Pat. No. 5,169,682, U.S. Pat. No. 6,120,213, to which US patents reference is made and which US patents are hereby further incorporated in the present specification by reference.

The technique of using calcium carbonate material contained within a filter bag is also known in the art, and is described among others in international patent application, application No. PCT/NO00/00386, publication No. WO 01/38230.

In manufacturing pre-filled and sealed filter bags containing calcium carbonate material, a desire exists for a bag having a fairly large content of calcium carbonate for providing the water rinsing ability, however, through experiments which have been made by the present inventors, it has been realised that the prior art pre-filled and sealed filter bags containing calcium carbonate material are not properly functioning, mainly for the reason that the filter bags tend to sink rapidly through the water, in which the pre-filled and sealed filter bag is immersed. By the rapid sinking, a fairly slow rinsing process is performed since the water is only rinsed during the circulation of water through the pre-filled and sealed filter bag positioned at the bottom of a container, in which the water is contained, which water is to be rinsed.

An object of the present invention is to provide a pre-filled and sealed filter bag containing calcium carbonate, which filter bag provides an improved and more rapid rinsing operation, as the filter bag itself tends to be floating in the water for an extended period of time, such as half a minute or several minutes, thereby allowing the calcium carbonate material to perform its rinsing function during the immersing process rather than only at the bottom of the container.

It is a feature of the present invention that a specific selection of the weight of the filter paper used in the pre-filled and sealed filter bag according to the present invention surprisingly allows the pre-filled and sealed filter bag to maintain its floating capability for a fairly large or at least an extended period of time as compared to a prior art pre-filled and sealed filter bag which sinks rapidly through the water in which it is immersed.

The above object, the above feature together with numerous other objects, features and advantages, which will be evident from the below detailed description of a presently preferred embodiment of the pre-filled and sealed filter bag according to the present invention is in accordance with the teachings of the present invention obtained by a pre-filled and sealed filter bag containing calcium carbonate material having fine pores, such as coral sand, oyster shells and/or crab shells and comprising:

two sheets of filter paper material having substantially the same geometrical shape and dimensions and defining an outer periphery,

a peripheral joint extending along said outer periphery of said sheets of filter paper material and joining said sheets together substantially overlapping one another and defining an inner chamber within the interior of said bag, in which said material is enclosed,

wherein each of said two sheets of filter paper material define within said peripheral joint an air and water permeable filter area of a minimum of 900 mm², preferably a filter area of no less than 900 mm², such as 1000 mm² and

wherein the weight of said two sheets of filter paper material constitute more than ⅛ (12.5%) of the weight of said material contained within said filter bag.

Surprisingly, it has been realised that a pre-filled and sealed filter bag having a fairly large permeable filter area of approximately 1000 mm² corresponding to a filter bag measuring approximately 25-30 mm×35-40 mm may be provided as a floating pre-filled and sealed filter bag provided the weight of the sheets of filter paper material constitutes more than 12.5% of the weight of calcium carbonate material contained within the filter bag. A reasonable size of the pre-filled and sealed filter bag which is easily handled by a user for rinsing e.g. a cup of coffee, a cup of tea or a glass of water, may include approximately 0.5 g of calcium carbonate material.

It is contemplated that the floating ability of the pre-filled and sealed filter bag according to the present invention is at least to some extent dependent of the permeability of the filter paper material as a high permeability will cause the air contained within the pre-filled and sealed filter bag before immersing the filter bag in water and also present within filter paper material to be rapidly transferred from the inner chamber of the filter bag and from the filter paper material of the filter bag into water, thereby causing a rapid shift of the filter bag from being floating to be rapidly sinking. Therefore, in order to slow down this process of transfer of air trapped within the filter paper material of the filter bag into the water, the air permeability of the filter paper material should be fairly low, still, for allowing the water to be permeating through the filter paper material, the two sheets of the filter paper material preferably have a permeability of more than 1.2 l/sec (air permeability).

In the presently preferred embodiment of the bag according to the present invention, the two sheets of filter paper material exhibit a density of grammage of 15-25 g/m², such as approximately 20 g/m², which, in combination with the above-mentioned permeability and further, the above discussed percentage of filter paper material relative to calcium carbonate material contained within the filter bag provides an advantageous embodiment of the above-described size.

Preferably, the two sheets of filter paper material each exhibit a caliper of 50-150 μm, such as 60-120 μm, preferably approximately 80-110 μm, further preferably approximately 80-100 μm or approximately 90 μm.

For the proper handling of the pre-filled and sealed filter bag and also for preventing that a filter bag unintentionally leaks during the intentional use of the filter bag used as a consumer or industrial product for rinsing, e.g. coffee, tea, water and wine etc., the filter paper material has to stand certain strength criteria and consequently, the two sheets of filter paper material preferably each exhibit a Wet Burst Strength of more than 15 kPa, such as 15-30 kPa, e.g. 18-25 kPa, e.g. 20-22 kPa. For allowing the bag to be handled before immersing the bag into water and/or for allowing the bag to be transported from one location to another, the two sheets of filter paper material preferably each exhibit a dry tensile strength of more than 50 g/mm, such as 50-100 g/mm, e.g. 60-120 g/mm, e.g. 60-100 g/mm, preferably approximately 75 g/mm, and the two sheets of filter material preferably also each exhibit a seal strength potential of more than 250 g/50 mm, such as 250-400 g/50 mm, e.g. 300-400 g/50 mm, preferably approximately 350-400 g/50 mm, further preferably approximately 375 g/50 mm.

As discussed above, the bag according to the present invention preferably has outer dimensions of approximately 25-30 mm×35-40 mm, preferably approximately 28 mm×38 mm.

According to a particular aspect of the present invention, it has been realised that the calcium carbonate material contained within the pre-filled and sealed filter bag according to the present invention is preferably composed of (A) calcium ascorbate, (B) a water-soluble buffer independently selected from coral sand and shell sand, wherein the water-soluble buffer contains coral sand constituting less than 5% of the total weight of the material. It has been realised through experiments that the above composition of the calcium carbonate containing material provides an excellent water rinsing ability.

According to a particular embodiment of the filter bag according to the present invention, the water-soluble buffer constituting less than 90% of the total weight of said composition and further preferably constituting at least 95% of the total weight of the material.

The water-soluble buffer may be constituted by any appropriate and relevant material compatible with any of the constituents of the calcium carbonate material itself and may e.g. be constituted by coral sand or shell sand.

The shell sand may originate from any mechanically ground shells such as crab shells or oyster shells, which are available in fairly large quantities along the Atlantic coasts of Northern Europe.

According to a further advantageous embodiment of the filter bag according to the present invention, the material preferably further comprises a gel agent, which may be constituted by e.g. chitosan.

The invention is now to be further described with reference to the drawings, in which

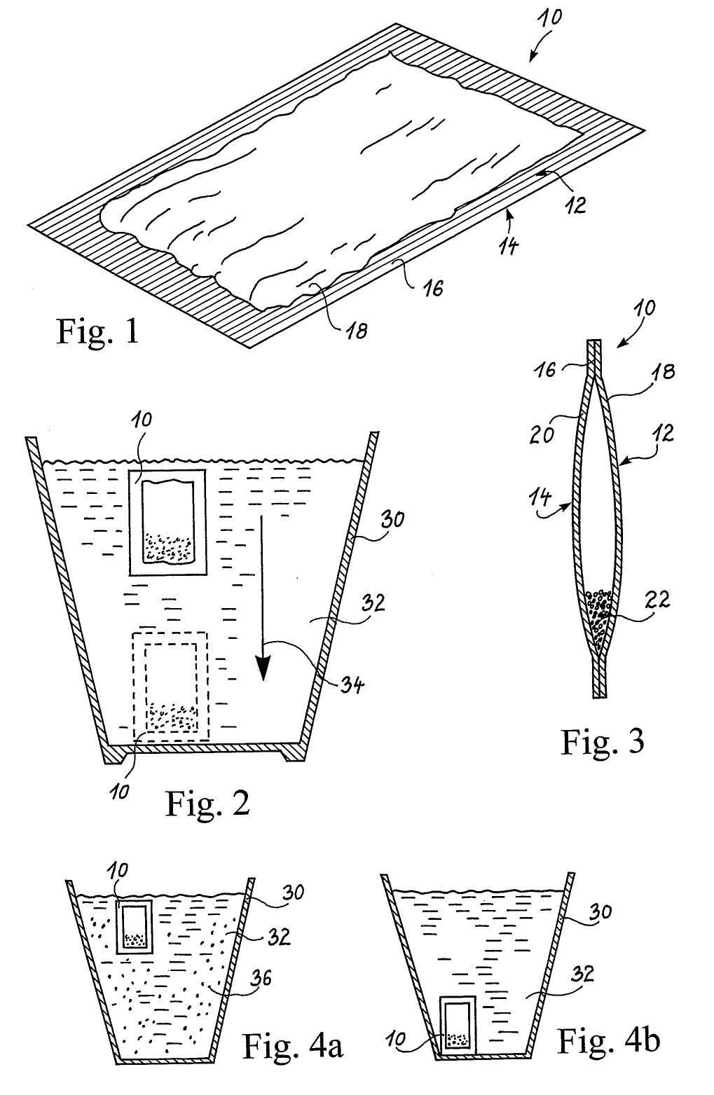

FIG. 1 is a perspective and schematic view of a first and presently preferred embodiment of a pre-filled and sealed filter bag according to the present invention,

FIG. 2 is a schematic and vertical sectional view of a water containing container in which the filter bag shown in FIG. 1 is immersed,

FIG. 3 is a vertical sectional view of the filter bag shown in FIG. 1, and

FIGS. 4a and 4b are schematic and vertical sectional views similar to the view of FIG. 2 illustrating the ability of the material contained within the filter bag to rinse the water during the immersing of the filter bag into the water contained within the container shown in FIGS. 4a and 4b.

In FIG. 1, a pre-filled and sealed filter bag according to the present invention is shown, which filter bag is also shown in FIG. 3.

The filter bag is made from two sheets of porous filter paper, such as the paper sheet supplied from the company J R Crompton Limited, Manchester, UK and sold under the trade name HEATSEAL™. The sheet material is a plane paper sheet manufactured from a blend of high quality manila hemp, cellulose and thermoplastic fibres. The sheet complies with the legislation of the United States (FDA 21 CFR 176.170) and of Germany (Lebensmittel—und Bedarfsgegenständegesetze vom 15.08.74 sections 30 and 31) of UK (Materials and Articles in Contact with Food Regulations 1987) and appropriate EU legislation.

The two sheets are constituting a top sheet 12 and a bottom sheet 14 being co-extensive and having substantially identical outer dimensions and having rectangular configurations. The two sheets 12 and 14 are welded together along the outer periphery of the two sheets, which weld is designated the reference numeral 16 and which weld seam is established by applying heat to the two sheets causing the thermoplastic fibres to melt and integrally bonding the two sheets together. Within the circumferential seal 16 extending along the outer periphery of the two sheets 12 and 14, two exposed areas are defined, the area of the sheet 12 being designated the reference numeral 18 and similarly the exposed area of the sheet 14 is designated the reference numeral 20. According to a characteristic feature of the filter bag shown in FIG. 1, the exposed filter area is of a minimum size of 900 mm², such as preferably approximately 1000 mm², as the two sheets preferably have outer dimensions of 28 mm×38 mm providing a total outer area of 1064 mm².

Within the filter bag, a calcium carbonate material having fine pores, such as coral sand, oyster shells and/or crab shells, is included together with a water soluble buffer. According to a further feature of the filter bag according to the present invention, the two sheets of paper material constitutes a fairly large percentage of the total weight for providing a sufficient floating capability allowing the filter bag when used, as will be described below with reference to FIG. 2, to float within water rather than rapidly sinking through the water contained within a container, which water is to be rinsed by means of the calcium carbonate material contained within the filter bag.

According to the teachings of the present invention for providing an adequate floating capability, the weight of the two sheets of filter paper constitute more than ⅛ of the weight of the calcium carbonate material of the bag or more than 12.5% of the weight of the content of the filter bag. As will be understood, the above percentage has been established empirically and the percentage is construed to be independent of the kind of paper material chosen, however, may to some extent, dependent of the porousness of the present material, as a micro-porous filter material includes initially a large amount of air concealed within the filter bag and within the micro-porous of the filter material, which air is fairly slowly liberated to the water and in doing so causes the filter bag to sink or be immersed into the water.

In FIG. 3, the calcium carbonate material is designated the reference numeral 22.

In FIG. 2, the above described floating capability characteristic of the pre-filled and sealed filter bag according to the present invention is illustrated as the filter bag 10 is immersed within a container 30 in which a volume of water 32 is enclosed and as illustrated in FIG. 2, the filter bag 10 sinks fairly slowly through the water 32 due to the fairly high content of fibre material of the sheets 12 and 14. The low sinking is illustrated in FIG. 2 by an arrow 34 illustrating the distance of travel for a period of time, such as several minutes from the original of the filter bag 10 shown at the top of the water 32 to a bottom position shown in dotted line at the bottom of the container 30.

In FIGS. 4a and 4b, the ability of rinsing the water 32 is illustrated as in FIG. 4a illustrating the initial step of immersing the filter bag into the water 32 in the top position, a number of impurities 36 are present within the water 32, whereas in FIG. 4b illustrating the final position of the bag 10 after the slow immersing through the water 32, no impurities or substantially no impurities are present, which is illustrated by the lack of presence of any impurities similar to the impurities 36 shown in FIG. 4a.

### EXAMPLE

A prototype embodiment of the filter bag 10 shown in FIG. 1 was made from HEATSEAL™ paper of the grade reference 474604 supplied from the above company J R Crompton Limited. The filter material exhibited the following properties:

| | | | |
|---|---|---|---|
| Grammage | g/m² | | 21.0 |
| Air Permeability | m³/min/m² | | 50 |
| Caliper | μm | | 89 |
| Wet Burst Strength | kPa | | 22 |
| Dry Tensile Strength | g/mm | MD | 98 |
| | | CD | 34 |
| Seal Strength Potential | g/50 mm | | 377 |

The calcium carbonate material was a mixture of coral sand and shell sand including less than 5% of coral sand of the total amount of the calcium carbonate material and which buffer constitutes less than 5% of the total weight of the material. The gel was constituted by chitosan and the shell sand originated from crabs or oysters.

The filter bag 10 made from the above material measured 28 mm×38 mm and an exposed area within the circumferential heat seal 16 was larger than 900 mm, such as 950 mm.

The content of calcium carbonate material was 0.50 g and the weight of the sheets 12 and 14 was 0.060 g.

1. A pre-filled and sealed filter bag containing calcium carbonate material having fine pores, comprising:
two sheets of filter paper having substantially similar geometrical shape and dimensions and defining an outer periphery; and
a peripheral joint extending along said outer periphery of said sheets of filter paper and joining said sheets together substantially overlapping one another to define an inner chamber within the interior of said filter bag, in which said calcium carbonate material is enclosed;
wherein each of said two sheets of filter paper define within said peripheral joint an air and water permeable filter area of a minimum of 900 mm², and the weight of said two sheets of filter paper constitutes more than ⅛ (12.5%) of the weight of said calcium carbonate material contained within said filter bag.

2. The bag according to claim 17 wherein each of said two sheets of filter paper comprises a permeability of more than 1.2 l/sec.

3. The bag according to claim 1, wherein each of said two sheets of filter paper comprises a density or grammage of 15-25 g/m².

4. The bag according to claim 1, wherein each of said two sheets of filter paper comprises a caliper of 50-150 μm.

5. The bag according to claim 1, wherein each of said two sheets of filter paper comprises a wet burst strength of more than 15 kPa.

6. The bag according to claim 1, wherein each of said two sheets of filter paper comprises a dry tensile strength of more than 50 g/mm.

7. The bag according to claim 1, wherein each of said two sheets of filter paper comprises a seal strength potential of more than 250 g/50 mm.

8. The bag according to claim 1, wherein each of said two sheets of filter paper comprises outer dimensions of approximately 25-30 mm×35-40 mm.

9. The bag according to claim 1, wherein said calcium carbonate material comprises
calcium ascorbate, and
a water-soluble buffer selected from coral sand and shell sand, wherein the water-soluble buffer includes coral sand constituting less than 5% of the total weight of the calcium carbonate material.

10. The bag according to claim 9, wherein the water-soluble buffer comprises at least 90% of the total weight of said calcium carbonate material.

11. The bag according to claim 9, wherein the water-soluble buffer comprises at least 95% of the total weight of the calcium carbonate material.

12. The bag according to claim 9, wherein the water-soluble buffer comprises coral sand.

13. The bag according to claim 9, wherein the water-soluble buffer comprises shell sand.

14. The bag according to claim 13, wherein the shell sand originates from crab shells or oyster shells.

15. The bag according to claim 1, wherein the calcium carbonate material further comprises a gel agent.

16. The bag according to claim 15, wherein the gel agent is chitosan.
